(19) United States
(12) Patent Application Publication
(10) Pub. No.: US 2023/0404001 A1
(43) Pub. Date: Dec. 21, 2023

(54) GROWING APPARATUS AND METHOD FOR GROWING PLANTS

(71) Applicant: Ivan MALLINOWSKI, Wassenberg (DE)

(72) Inventor: Ivan MALLINOWSKI, Wassenberg (DE)

(21) Appl. No.: 18/125,324

(22) Filed: Mar. 23, 2023

Related U.S. Application Data
(63) Continuation of application No. PCT/EP21/76153, filed on Sep. 23, 2021.

(51) Int. Cl. A01G 31/04; A01G 29/00

(52) U.S. Cl. CPC A01G 31/042; A01G 29/00

(57) ABSTRACT

A growing apparatus for plants, the growing apparatus including a planting side; a harvesting side; a flexible conveyor belt including cutouts that transports the plants in the cutouts along a conveying path from the planting side to the harvesting side; a nutrition device that feeds a liquid nutrition medium for the plants to a root side of the flexible conveyor belt so that the plants root at the root side and sprout at an illuminated sprout side of the conveyor belt that is arranged opposite to the root side, wherein the flexible conveyor belt is folded into creases at the planting side wherein the creases extend in a direction transversal to the conveying path, wherein the creases are moved from the planting side to the harvesting side and thus straightened and leveled along the conveying path, wherein the cutouts are respectively arranged on ridge lines of the creases.

### RELATED APPLICATIONS

This application is a continuation of International patent application PCT/EP2021/076153 filed on Sep. 23, 2021 claiming priority form German application DE 10 2020 125 581.0 filed on Sep. 30, 2020, both of which are incorporated in their entirety by this reference

### FIELD OF THE INVENTION

The invention relates to a growing apparatus for plants. The invention also relates to a growing method for the plants using the growing apparatus.

### BACKGROUND OF THE INVENTION

Growing apparatuses, and in particular industrial hydroponic methods for growing plants with liquid nutrient solutions instead of soil typically including artificial illumination are well known in the art. Special embodiments of hydroponics are in particular aquaponics, aeroponics and fogponics. In aquaponic methods fish and water animals are kept in the nutrient solution and their excrements fertilize the plants. In an aeroponic method the nutrient solution is sprayed or fogged on the root side. In a fogponics method the fogging is performed by ultrasonic foggers.

EP 3 409 103 A1 proposes to run the conveyor belt up and down in an alternating pattern in the growing apparatus in order to accelerate plant growth.

In the known growing apparatus, the plants grow through holes in the conveyor belt. The large distance between the plants on the planting side and free surfaces thus created facilitate growth of the plants in a longitudinal direction and a transversal direction of the conveyor belt. The artificial illumination of the free surfaces therefore does not help growth.

US 2008/029 5400 A1 discloses a growing apparatus with a flexible conveyor belt assembled from polyester fleece strips, wherein seeds are placed into grooves between the strips and the grooves are closed thereafter when the conveyor belt is put under tension in the feed direction.

WO 2016/023947 A1 discloses an additional growing apparatus with a flexible conveyor belt which is wound on rollers transversal to a feed direction and placed under tension along the conveying path so that the conveyor belt is successively unwound during operations.

WO 2009/067194A1 discloses a growing apparatus with a conveyor belt that runs endless from the planting side to the harvesting side and back.

U.S. Pat. No. 4,972,627 A discloses a growing apparatus with a conveyor belt made from open pore polyurethane.

U.S. Pat. No. 4,118,891 A discloses a growing apparatus with hoses that feed a nutrient medium to the plants.

### BRIEF SUMMARY OF THE INVENTION

It is an object of the invention to make the illumination of the plants more efficient.

Improving upon known growing apparatus the object is achieved by a growing apparatus for plants, the growing apparatus including a planting side; a harvesting side; a flexible conveyor belt including cutouts that transports the plants in the cutouts along a conveying path from the planting side to the harvesting side; a nutrition device that feeds a liquid nutrition medium for the plants to a root side of the flexible conveyor belt so that the plants root at the root side and sprout at an illuminated sprout side of the conveyor belt that is arranged opposite to the root side, wherein the flexible conveyor belt is folded into creases at the planting side wherein the creases extend in a direction transversal to the conveying path, wherein the creases are moved from the planting side to the harvesting side and thus straightened and leveled along the conveying path, wherein the cutouts are respectively arranged on ridge lines of the creases.

On the planting side the plants are moved closer together in the longitudinal direction of the conveying path due to the conveyor belt being folded into creases. This reduces a free surface between the plants that is illuminated without utility. Stretching and straightening the creases along the conveying path releases space in the longitudinal direction as required for a growth of the plant. The creases can be formed wave shaped or by creasing the conveyor belt.

Advantageously the conveyor belt in a growing apparatus according to the invention is essentially made from a plastic foil, further advantageously from polypropylene. The conveyor belt can thus be produced economically in any required shape. Performing an aeroponic method, the conveyor belt according to the invention furthermore prevents an uncontrolled transition of nutrient medium from the root side to the sprout side.

A conveyor belt made from polypropylene cleans easily and is resistant to humidity and light. Alternatively, the plastic foil can also be made from polyethylene (PE) polystyrol (PS), polyvinylchloride (PVC) or polycarbonate (PC) or from plural layers of identical or different materials.

Advantageously the conveyor belt is made from lamellas in a growing apparatus according to the invention wherein the lamellas adjoin in a direction transversal to the conveying path. Thus, the conveyor belt can be configured in a modular manner as required.

Advantageously the conveyor belt according to the invention runs endless from the harvesting side back to the planting side in a growing apparatus according to the invention. Thus, the conveyor belt facilitates continuous operations of the growing apparatus. Alternatively, harvested lamellas of a conveyor belt made from lamellas can be removed at the harvesting side and reapplied at the planting side.

Advantageously the plants are attached in the conveyor belt in an open pore foam material, further advantageously polyurethane foam, in a growing apparatus, according to the invention. On the one had side the foam material retains moisture for the plant and on the other hand side allows air to penetrate in order to prevent formation of mildew. Polyurethane foam has proven useful in hydroponics to attach plants.

Advantageously a growing apparatus according to the invention including a horizontally extending conveyor belt running transversal to the conveying path includes capillary hoses extending from the root side into the nutrition device wherein the capillary hoses feed the nutrient medium to the plants. In an aquaponic method, the capillary hoses supply the young plants at least provisionally or in a supplemental manner with the nutrient medium until the plants have formed their own sufficient roots that reach into the nutrient medium.

Alternatively, the growing apparatus according to the invention advantageously includes a fogger that fogs the nutrient medium and a gas conducting system which feeds the fogged nutrient medium to the root side. Further alternatively the root side can be fogged with the nutrient medium. In particular in aeroponic methods with a conveyor belt that extends vertically and transversal to the conveying path the plants are thus provided with the nutrient medium.

Advantageously a growing apparatus according to the invention includes an illumination device for illuminating the sprout side. The artificial illumination facilitates growing the plants independently from sun radiation and weather with defined environmental conditions.

Advantageously a growing apparatus according to the invention includes support elements at the conveyor belt and a drive device with a plurality of drive dogs that run the support elements along the conveying path. The drive with independent drive dogs facilitates a variation of the distance of the support elements and thus a size of the creases along the conveying path.

Advantageously the conveyor belt in the growing apparatus according to the invention includes guide holes at least at one edge along the conveying path, similar to the Remaliner™ punch holes in endless paper and bars formed as support elements between the support holes. The conveyor belt is then configured in a particularly simple and economical manner. The drive dogs can be mandrels or hooks formed at the drive device that are run through the guide holes.

Alternatively, a growing apparatus according to the invention with an advantageously horizontal or downward sloped conveying path can be operated without drive device when suitable support elements, e.g. clamps or bands keep the support elements at the respective desired distance. Alternatively, or in addition to the support elements, a weight or spring force impacting the conveyor belt, an elastic reset force of the conveyor belt itself and/or forces imparted by the plants upon each other can cause a stretching and leveling of the creases.

Advantageously sequential support elements in a drive device of a growing apparatus according to the invention, have a distance from each other that increases along the conveying path from the planting side to the harvesting side. The creases then have a height that decreases along the conveying path.

Advantageously the conveying path in a growing apparatus according to the invention has segments wherein the support elements respectively have a constant distance from each other within respective segments. The drive dogs of the segments can then be attached at orbiting conveyor chains in a particularly simple manner.

Advantageously the conveying path rises and falls in an alternating manner in the growing apparatus according to the invention. This accelerates plant growth.

Improving upon the known method it is proposed according to the invention that the conveyor belt is folded into creases transversal to the conveying path wherein the creases run from the planting side to the harvesting side and are thus stretched and leveled along the conveying path. The method according to the invention is performed in particular by a growing apparatus according to the invention and is characterized by the advantages recited supra.

Advantageously the plants are respectively placed on ridge lines of the creases in a method according to the invention. Placing only one row of plants on each respective crease generates uniform distances between rows which support uniform plant growth.

Advantageously, the plants are arranged offset from each other transversal to the conveying path on sequential creases in a method according to the invention in order to achieve a uniform distribution on the conveyor belt.

Advantageously planting blocks are attached in the conveyor belt and the plants are attached in the planting blocks according to the method according to the invention. The planting blocks simplify starting and handling the seedlings and cleaning the conveyor belt after harvesting.

Advantageously the conveyor belt is continuously moved from the planting side to the harvesting side according to the method according to the invention. The continuous movement without sudden position change closely corresponds to a natural situation in a field.

### BRIEF DESCRIPTION OF THE DRAWINGS

The invention is subsequently described based on advantageous embodiments with reference to drawing figures, wherein:

FIG. 1A illustrates a detail of a first growing apparatus according to the invention without plants;

FIG. 1B illustrates another detail of the first growing apparatus according to the invention without plants;

FIG. 2A illustrates a planting block of the growing apparatus according to the invention and cuts introduced into the planting block;

FIG. 2B illustrates the planting block of the growing apparatus according to the invention and the cuts introduced into the planting block;

FIG. 3A illustrates a growth step of a plant in a planting block;

FIG. 3B illustrates another growth step of the plant in the planting block;

FIG. 3C illustrates another growth step of the plant in the planting block;

FIG. 3D illustrates another growth step of the plant in the planting block;

FIG. 3E illustrates another growth step of the plant in the planting block;

FIG. 3F illustrates another growth step of the plant in the planting block;

FIG. 4 illustrates a schematic view of the first growing apparatus according to the invention;

FIG. 5 illustrates a schematic view of a second growing apparatus according to the invention; and

FIG. 6 illustrates a detail of a conveyor belt of another growing apparatus according to the invention.

### DETAILED DESCRIPTION OF THE INVENTION

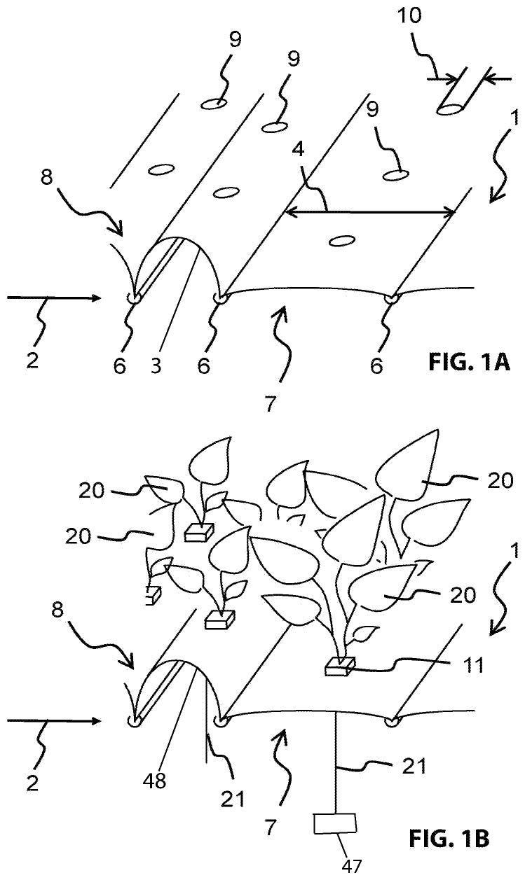

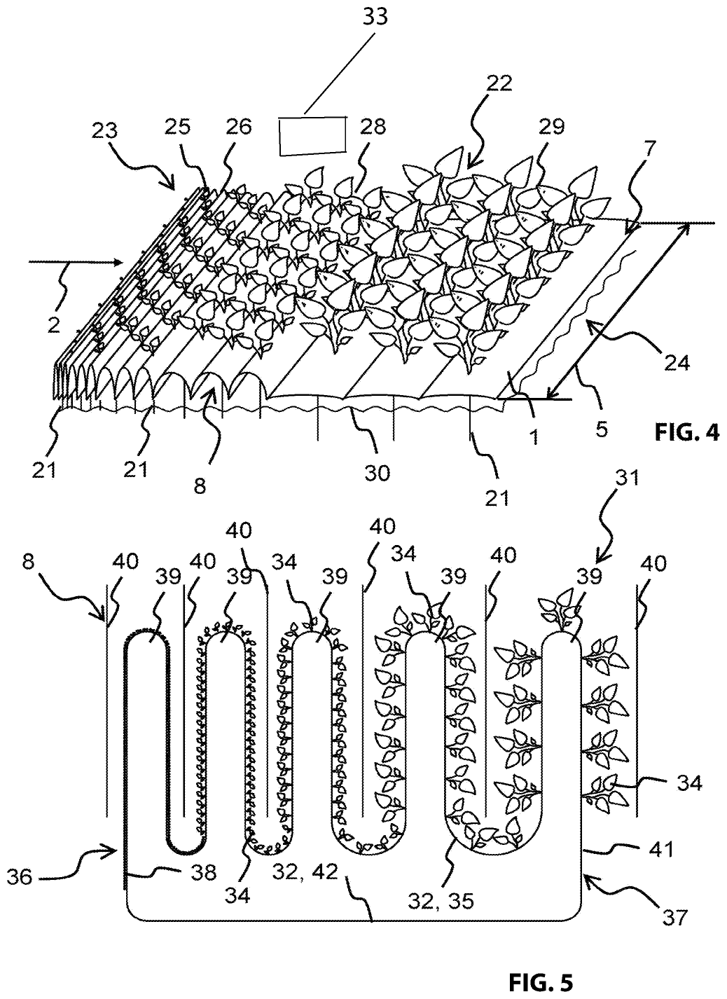

The conveyor belt 1 shown in a detail view in FIG. 1A, is made from fifteen lamellas 3 adjoining each other in the direction of the conveying path 2 having a width 4 of 30 cm respectively and a length 5 of 120 cm shown in FIG. 4. The lamellas 3 are made from a polypropylene foil with a thickness of 0.8 mm wherein the lamellas are respectively connected with each other in tubular support elements 6.

The lamellas 3 and the conveyor belt 1 have a root side 7 and a sprout side 8, and circular cut outs 9 centrally arranged between the support elements 6 and having a diameter 10 of 40 mm, wherein planting blocks 11 can be inserted into the cut outs as illustrated in FIG. 1B.

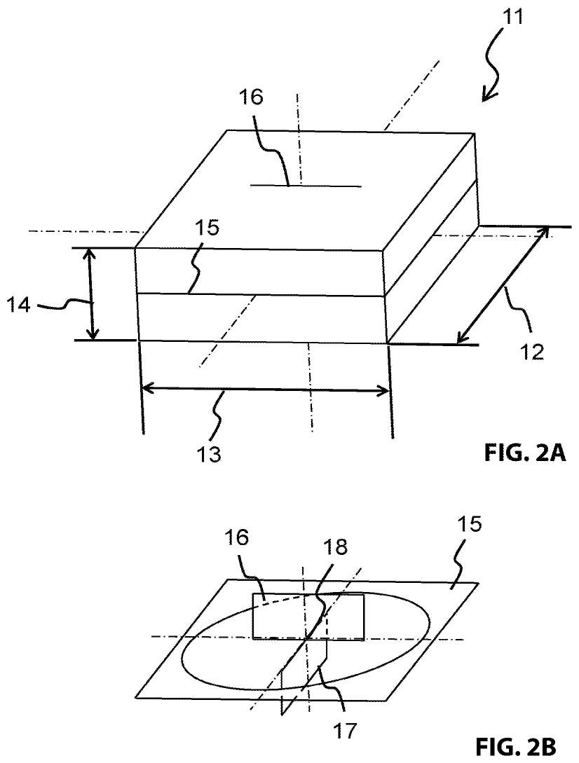

The planting blocks 11 illustrated in detail in FIG. 2A are made from open pore polyurethane foam with a width 12 and a length 13 of 50 mm respectively and a height 14 of 25 mm. Cuts 15, 16 17 are introduced into each planting block 11 as illustrated in FIG. 2B, namely a horizontal circular cut 15 about the center 18 with the diameter 10 of the cut outs 9 and two vertical cuts 16, 17 arranged transversal to each other and extending to the center 18.

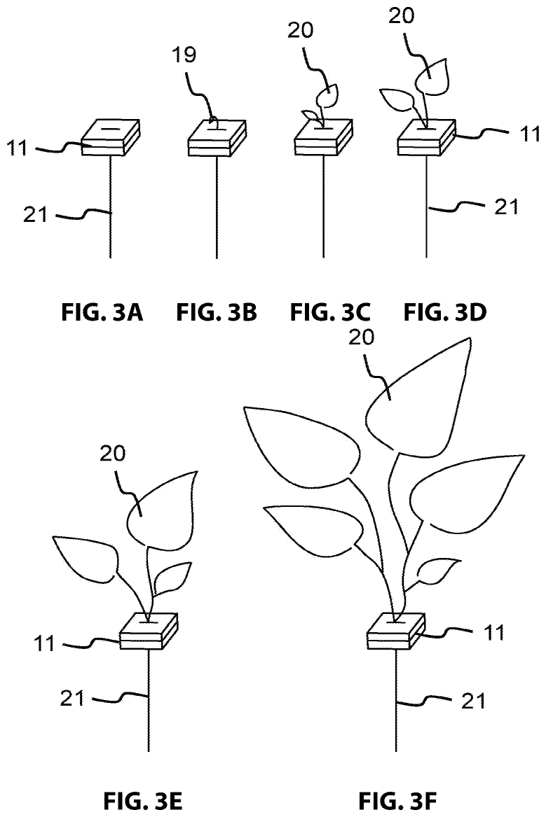

FIGS. 3A-3F show six growth phases in a plant block 11 starting with a seed kernel (FIG. 3A) through the seedling 19 (FIG. 3B) to the harvestable plant 20 (FIG. 3F). Until proper roots are formed the seed kernel and the growing plant 20 are supplied through a capillary hose 21. The seed kernel and the roots are not shown.

In the first growing apparatus 22 according to the invention schematically shown in FIG. 4 the conveyor belt 1 runs along the conveying path 2 from a planting side 23 to a harvesting side 24. The planting blocks 11 with the pre sprouted seedlings are introduced into the holes of the first lamella on the planting side 23. The support elements 6 of three adjoining lamellas 3 have a starting distance of 5 cm in a first segment 25 in the direction of the conveying path 2, a distance of 10 cm in a second segment 26, a distance of 15 cm in a third segment 27, a distance of 20 cm in a fourth segment 28 and an end distance of 25 cm in a fifth segment 29. The capillary hoses 21 are hanging vertically downward into a tub of a nutrition device 47 including a liquid nutrition medium 30. The distances are not illustrated in the drawing figure.

The support element 6 of the conveyor belt 1 contact lateral walls of the first growing apparatus 22, sequential support elements 6 are supported by clamps with different lengths against an elastic reset force of the lamellas 3 and a weight force of plants 20 at a respective distance from each other. The walls and the clamps are not illustrated in the drawing figure.

After a growth period of two days respectively three lamellas 3 are removed respectively at the harvesting side 24 and reapplied at the planting side 23 with the starting distance and new seedlings 19. The distance of the remaining lamellas 3 is increased accordingly by replacing the clamps. The plants 20 are harvested from the initially inserted lamellas 3 after 10 days.

The second growing apparatus 31 according to the invention illustrated in FIG. 5 includes a conveyor belt 32, an illumination device 33 and a nutrition device 47 and a drive device. The drive device is not illustrated.

The conveyor belt 32 is configured from the lamellas 3 known from the first growing apparatus 22, wherein the lamellas 3 are connected by the support element 6, described supra. The lamellas and the support elements are not illustrated in the drawing figure.

The conveyor belt 32 feeds plants 34 along a conveying path 35 during a growth phase of 10 days from a planting side 36 to a harvesting side 37 of the growing apparatus 31. Starting from the planting side 36 where the pre sprouted seedlings 38 are applied to the conveyor belt 32 as described supra the conveying path runs in five segments 39 initially vertically upward and thereafter vertically downward to the harvesting side 37 and from the harvesting side 37 below the segments 39 back to the planting side 36. The segments 39 have increasing distances from each other moving from the planting side 36 to the harvesting side 37 in order to avoid a collision of the plants 34.

The illumination device 33 includes six LED panels 40 respectively arranged at the planting side 36 and the harvesting side 37 and between two respectively adjacent segments 39 and illuminates a sprout side 41 of the lamellas and of the conveyor belt 32 in an artificial day/night rhythm.

The planting blocks correspond essentially to the planting blocks 11 of the first growing apparatus 22, however do not have the capillary hose of the first growing apparatus 22.

The nutrition device 47 includes a reservoir with a liquid nutrition medium for the plants 34, an ultrasound fogger for the nutrition medium and conduits for uniform distribution of the fog, on a root side 42 of the conveyor belt 32 that is opposite to the sprout side 41.

The drive device includes an orbiting conveyor chain with drive dogs for the support elements for each of the segments 39, wherein the distances of the drive dogs and the support elements increase from a starting distance of 5 cm at the planting side 36 in increments of 5 cm respectively to the harvesting side 37 to an end distance of 25 cm between the segments 39.

The second growing apparatus 31 can be operated with a conveyor belt 43 that runs transversal to the conveying path 35 in a horizontal or vertical direction.

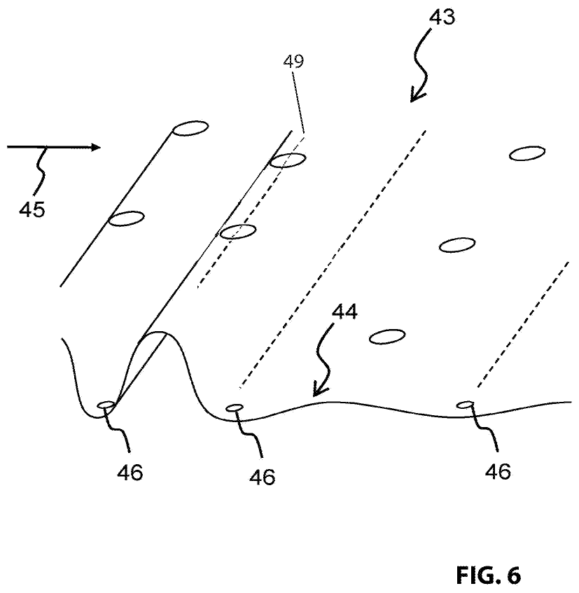

A third embodiment of the growing apparatus according to the invention essentially corresponds to the first growing apparatus 22 but includes a different drive device. The conveyor belt 43 of the third embodiment of the growing apparatus shown in FIG. 6 in detail includes support holes 36 arranged with uniform distances at both edges 44 along the conveying path 45. The drive device includes domes moved along the conveying path 45 with variable distance continuously from the planting side to the harvesting side, wherein the domes are supported by the support holes.

### REFERENCE NUMERALS AND DESIGNATIONS

1 conveyor belt
2 conveying path
3 lamellas
4 width
5 length
6 support element
7 root side
8 sprout side
9 cut out
10 diameter
11 planting block
12 width
13 length
14 height
15 sectional view
16 sectional view
17 sectional view
18 center
19 seedling
20 plant
21 capillary hose
22 growing apparatus
23 planting side
24 harvesting side
25 segment
26 segment
27 segment
28 segment
29 segment
30 nutrient medium
31 growing apparatus
32 conveyor belt
33 illumination device
34 plant
35 conveying path
36 planting side
37 harvesting side
38 seedling
39 segment
40 LED panel
41 sprout side
42 root side
43 conveyor belt
44 edge
45 conveying path
46 support hole
47 nutrition device
48 crease
49 ridge line

What is claimed is:

1. A growing apparatus for plants, the growing apparatus comprising:
a planting side;
a harvesting side;
a flexible conveyor belt including cutouts that transports the plants in the cutouts along a conveying path from the planting side to the harvesting side;
a nutrition device that feeds a liquid nutrition medium for the plants to a root side of the flexible conveyor belt so that the plants root at the root side and sprout at an illuminated sprout side of the conveyor belt that is arranged opposite to the root side,
wherein the flexible conveyor belt is folded into creases at the planting side wherein the creases extend in a direction transversal to the conveying path, wherein the creases are moved from the planting side to the harvesting side and thus straightened and leveled along the conveying path,
wherein the cutouts are respectively arranged on ridge lines of the creases.

2. The growing apparatus according to claim 1, wherein the flexible conveyor belt is made from a synthetic material foil or from polypropylene.

3. The growing apparatus according to claim 1, wherein the flexible conveyor belt is made from lamellas that adjoin in a direction transversal to the conveying path.

4. The growing apparatus according to claim 1, wherein the flexible conveyor belt runs endless from the harvesting side back to the planting side.

5. The growing apparatus according to claim 1, wherein the plants are attached in the flexible conveyor belt in an open pore foam material or in a polyurethane foam.

6. The growing apparatus according to claim 1, wherein capillary hoses run from the root side into the nutrition device and feed the nutrition medium to the plants.

7. The growing apparatus according to claim 1, further comprising: a fogger that fogs the nutrient medium and a gas conducting system that feeds fogged nutrient medium to the root side.

8. The growing apparatus according to claim 1, further comprising: an illumination device configured to illuminate the sprout side.

9. The growing apparatus according to claim 1, further comprising: support elements arranged at the flexible conveyor belt and a drive device with a plurality of drive dogs that support the support elements along the conveying path.

10. The growing apparatus according to claim 1, wherein the flexible conveyor belt includes support holes at least at one edge along the conveying path and bars configured as support elements arranged between the support holes.

11. The growing apparatus according to claim 10, wherein adjacent support elements have a distance from each other that increases along the conveying path from the planting side to the harvesting side.

12. The growing apparatus according to claim 11, wherein the conveying path includes segments in which the support elements respectively have a constant distance from each other.

13. The growing apparatus according to preceding claim 1, wherein the conveying path rises and falls in an alternating pattern.

14. A method for growing plants, the method comprising:
planting the plants on a planting side on a flexible conveyor belt;
transporting the plants on the flexible conveyor belt along a conveying path from the planting side to a harvesting side and harvesting the plants on the harvesting side;
feeding a liquid nutrition medium for the plants to a root side of the flexible conveyor belt;
illuminating a sprout side of the flexible conveyor belt that is arranged opposite to the root side so that the plants root at the root side and sprout at the sprout side;
folding the flexible conveyor belt into creases at the planting side wherein the creases extend in a direction transversal to the conveying path and moving the creases from the planting side to the harvesting side and thus straightening and leveling the creases along the conveying path,
wherein the plants are respectively placed on ridge lines of the creases.

15. The method according to claim 14, wherein the plants are arranged offset from each other transversal to the conveying path on sequential creases.

16. The method according to claim 14, wherein planting blocks are attached in the flexible conveyor belt and the plants are attached in the planting blocks.

17. The method according to claim 14, wherein the conveyor belt is continuously moved from the planting side to the harvesting side.
